(19) United States
(12) Patent Application Publication
(10) Pub. No.: US 2016/0307262 A1
(43) Pub. Date: Oct. 20, 2016

(54) SHOPPING SUPPORTING APPARATUS AND SHOPPING SUPPORTING METHOD

(71) Applicant: CASIO COMPUTER CO., LTD., Tokyo (JP)

(72) Inventors: Yoshihiro SATO, Asaka-shi (JP); Hiroshi AKAO, Tokyo (JP); Hideo SUZUKI, Tokyo (JP); Kiyoshi OGISHIMA, Tokyo (JP)

(73) Assignee: CASIO COMPUTER CO., LTD., Tokyo (JP)

(21) Appl. No.: 15/077,692

(22) Filed: Mar. 22, 2016

(30) Foreign Application Priority Data
Apr. 20, 2015 (JP) 2015-085920

(51) Int. Cl. G06Q 30/06

(52) U.S. Cl. CPC G06Q 30/0635; G06Q 30/0641

(57) ABSTRACT

A shopping memo which is easy to dairy use can be prepared in a simple manner. A smart phone is provided with a shopping-memo preparing unit and an indication processing unit. The shopping-memo preparing unit registers commodity information on an electronic receipt to a shopping list in response to user's operation to prepare shopping-memo data. The indication processing unit displays an electronic receipt in such a manner that allows a user to clearly discriminate whether or not each piece of commodity information has been registered to a shopping list of the shopping-memo data prepared in the past by the shopping-memo preparing unit.

### CROSS-REFERENCE TO RELATED APPLICATION

The present application is based upon and claims the benefit of priority from the prior Japanese Patent Application No. 2015-085920, filed Apr. 20, 2015, the entire contents of which are incorporated herein by reference.

### BACKGROUND OF THE INVENTION

1. Field of the Invention

The present invention relates to a shopping supporting apparatus and a shopping supporting method.

2. Description of the Related Art

In recent, an electronic receipt system is proposed, in which POS (Point Of Sales) terminal converts information of a receipt into electronic data, and a customer uses his/her mobile terminal and/or personal computer to obtain the electronic data of the receipt, whereby the electronic data of the receipt can be exchanged between the POS terminal and the mobile terminal and/or personal computer. One example of the electronic receipt systems is such that POS terminal obtains the identification information of the customer and associates the customer's identification information with information of the electronic receipt generated by the POS terminal, and further the POS terminal stores the associated data in a database of a server which is connected to the mobile terminal and/or personal computer through a network. The customer of the mobile terminal or personal computer uses his/her identification information to access to the database of the server and downloads information of his/her desired electronic receipt.

Using the electronic receipts, the customer can keep his/her household account book automatically and electronically, and the customer is not required to receive unwanted paper receipts. Therefore, the electronic receipt system is very convenient for the customer. Meanwhile, the employment of electronic receipts can reduce consumption of paper receipts and can simplify sales clerks' operation of handing the paper receipts to customers. Therefore, the electronic receipts will be very convenient for the stores employing the electronic receipt system. It is expected that the advantages of the electronic receipt system will promote employment of the same system in future.

In the meantime, sometimes the customer prepares and keeps a memo for shopping at a store to prevent from forgetting purchasing the goods. But an operation of preparing such shopping memo or a shopping list by hand-writing will be troublesome for the customer. A solution to such a troublesome working is an employment of the electronic receipts, that is, it will be proposed to refer to electronic receipts to prepare the shopping list, requiring no troublesome work for preparing the hand-written shopping list.

Japanese Unexamined Patent Publication No. 2009-59173 discloses an electronic receipt system, in which only a mobile terminal specialized for the system is used to refer to a purchase history to prepare a shopping list.

In general, the customer does shopping repeatedly on a daily basis. But in the electronic receipt system disclosed by Japanese Unexamined Patent Publication No. 2009-59173, since it is supposed only to prepare a shopping memo singly, the customer is required to do troublesome hand-writing work to prepare the shopping memo, and the priority of the memo in hand-writing is not clearly decided.

In shopping, the customer chooses goods falling in a range varying to a certain extent. For example, the customer will buy any good in the same category and will not pay so much attention to the manufacture which has made such good. The disclosed electronic receipt system does not talk about this point, but mechanically compares the shopping memo with the electronic receipt and gives notice of the good that the customer forgets to buy. Therefore, when the customer has bought a substitute of the good, the system has given advice to the customer that he/she forgets to buy the good. The system will be hard to use for the customer. The present invention will provide an apparatus which is easily used on a daily basis to prepare to a shopping memo easy to use.

### SUMMARY OF THE INVENTION

According to one aspect of the invention, there is provided a shopping supporting apparatus which comprises a shopping memo preparing unit which registers commodity information indicated on an electronic receipt in a shopping list in response to a user's operation to prepare a shopping memo, and an indication processing unit which displays the electronic receipt that indicates in a distinguishable manner whether or not each piece of commodity information has been registered in the shopping list of the shopping memo that was prepared in the past by the shopping memo preparing unit.

The shopping supporting apparatus according to the invention is easy to use to prepare the shopping memo easy to use.

### BRIEF DESCRIPTION OF THE DRAWINGS

FIG. 1 is a view schematically showing a configuration of an electronic receipt system according to the embodiment of the invention.

FIG. 2 is a view showing a configuration of a smart phone used in the electronic receipt system according to the embodiment of the invention.

FIG. 3 is a view showing a sequence of processes for issuing an electronic receipt.

FIG. 4 is a view showing a logical composition of the electronic receipt system according to the embodiment of the invention.

FIG. 5 is a view showing an electronic receipt database stored in a server of the electronic receipt system.

FIG. 6 is a view showing an electronic receipt reference history stored in the smart phone.

FIG. 7 is a view showing a shopping-list registration history stored in the smart phone.

FIG. 8 is a view showing shopping-memo data stored in the smart phone.

FIG. 9 is a view showing an initial screen displayed by the shopping-memo application program.

FIG. 10 is a view showing an initial state of the new shopping-memo preparing screen.

FIG. 11 is a view showing a procedure of registering a good to the good list of the shopping-memo preparing screen.

FIG. 12 is a view showing the shopping check screen displayed by the shopping-memo application program.

FIG. 13 is a view showing the shopping memo screen displayed by the shopping-memo application program.

FIG. 14 is a view showing the shopping-memo comparing screen displayed by the shopping-memo application program.

FIG. 15 is a view showing the shopping-forgotten list screen displayed by the shopping-memo application program.

FIG. 16 is a view showing a mode transition of the shopping-memo application program.

FIG. 17 is a flow chart of a process of updating the shopping-forgotten list.

### DETAILED DESCRIPTION OF THE PREFERRED EMBODIMENTS

Now, the embodiments of the present invention will be described with reference to the accompanying drawings in detail.

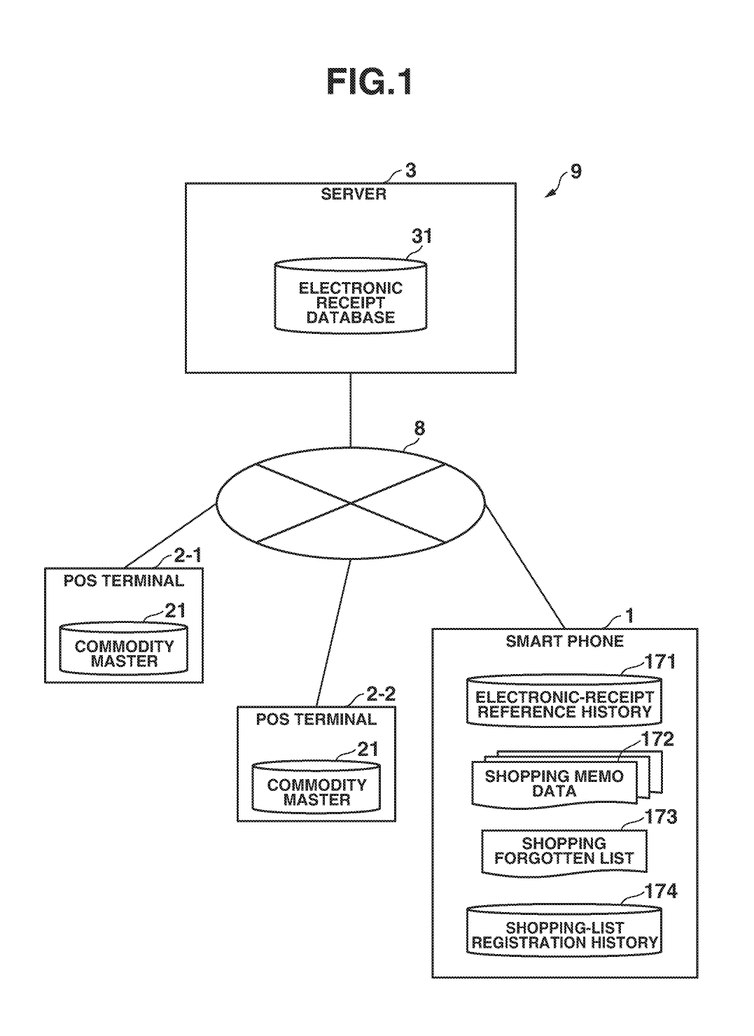

FIG. 1 is a view schematically showing a configuration of an electronic receipt system according to the embodiment of the invention.

The electronic receipt system 9 comprises a server 3, POS (Point Of Sales) terminals (settlement terminals) 2-1, 2-2, and smart phone 1, there elements being connected with each other through a network 8, as shown in FIG. 1.

The POS terminals 2-1, 2-2 are installed in stores respectively, and each of the POS terminals 2-1, 2-2 stores a commodity master 21 therein. The POS terminals 2-1, 2-2 are not restricted to 2 units, but any number of POS terminals can be used in the system. Further, it is possible to store the commodity master 21 in the server, which the POS terminals 2-1, 2-2 are allowed to refer to. Hereinafter, when it is not required to especially discriminate the POS terminals 2-1, 2-2 from each other, the POS terminals 2-1, 2-2 will be simply referred to as the “POS terminal 2”. The POS terminal 2 has a function of converting information of a receipt representing contents of a settled commerce into electronic data to produce an electronic receipt.

A public communication network, that is, the network 8 is connected with the POS terminals 2-1, 2-2, server 3 and smart phone 1, as shown in FIG. 1.

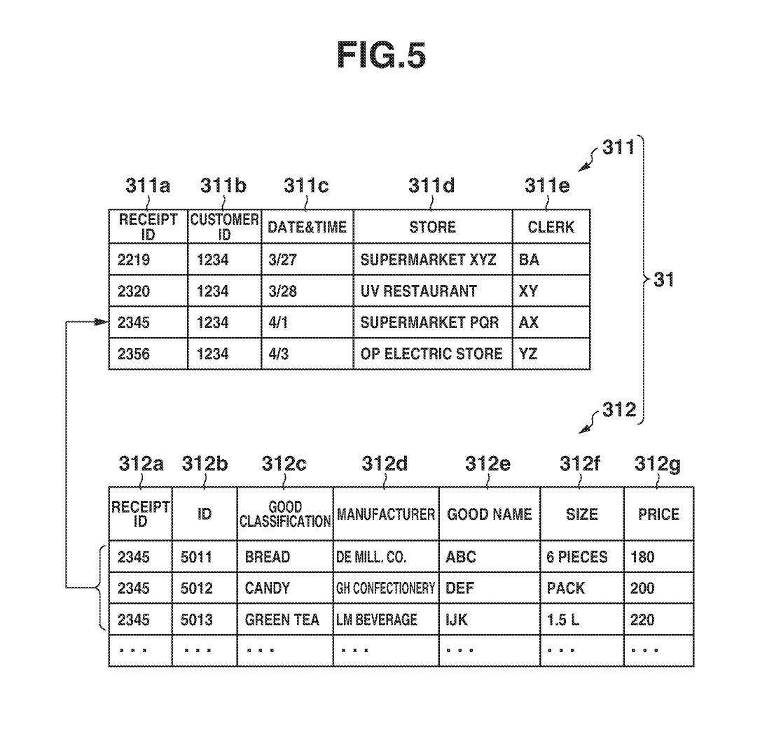

The server 3 stores an electronic receipt database 31 for memorizing electronic receipts produced by the POS terminal 2. Further, the server 3 stores the electronic receipt produced by the POS terminal 2 in the electronic receipt database 31 and sends the electronic receipt to the smart phone 1 through the network 8. The electronic receipt database 31 will be described with reference to FIG. 5 in detail later.

The smart phone 1 stores an electronic-receipt reference history 171, plural pieces of shopping-memo data 172, shopping-forgotten list 173, and shopping-list registration history 174. The smart phone 1 makes the POS terminal 2 recognize its own identification information at settlement of a commercial trade. Meanwhile, the POS terminal 2 associates the electronic receipt concerning the commercial trade with its own identification information and stores them in the server 3. The smart phone 1 is, for example, a mobile terminal which can be connected with the network 8, and has a function of accessing to the server 3 to selectively download from the server 3 the electronic receipt identified by the identification information. The history of references to these electronic receipts is stored in the electronic-receipt reference history 171.

The smart phone 1 is capable of producing, recording, and browsing electronic data of the shopping-memo data 172. Further, the smart phone 1 has a function of downloading the electronic receipt from the server 3 through the network 8, and comparing and collating receipt-information representing the electronic receipt with shopping-list information representing the shopping-memo data 172 to produce and display the shopping-forgotten list 173. The history registered in the shopping list of the shopping-memo data 172 is stored in the shopping-list registration history 174.

The server 3 and the smart phone 1 cooperate and serve as a shopping supporting apparatus.

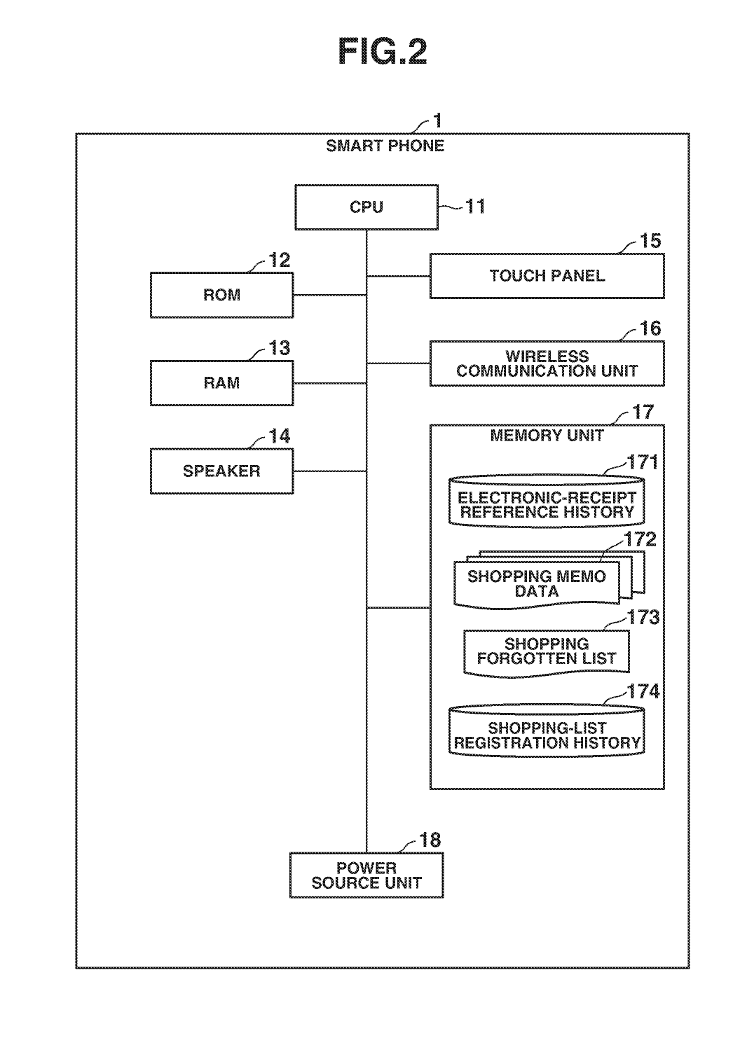

FIG. 2 is a view showing a configuration of the smart phone 1. As shown in FIG. 2, the smart phone 1 comprises CPU (Central Processing Unit) 11, ROM (Read Only Memory) 12, RAM (Random Access Memory) 13, a speaker 14, touch panel 15, wireless communication unit 16, memory unit 17, and power source unit 18.

CPU 11 composes a whole controlling unit of the smart phone 1. ROM 12 is a non-volatile area for recording various sorts of programs and data. RAM 13 is an area for temporarily storing various sorts of data to be used in calculations.

The speaker 14 serves as a notifying unit for generating various sounds such as alarm sounds. The touch panel 15 displays browsing screens including an electronic receipt and a shopping memo together with operation buttons. The touch panel 15 detects tapping operation performed onto the operation buttons to receive operation information. The wireless communication unit 16 communicates with the server 3 through the network 8. The memory unit 17 consists of, for example, a flash memory, and stores the electronic-receipt reference history 171, plural pieces of shopping-memo data 172, shopping-forgotten list 173, and shopping-list registration history 174.

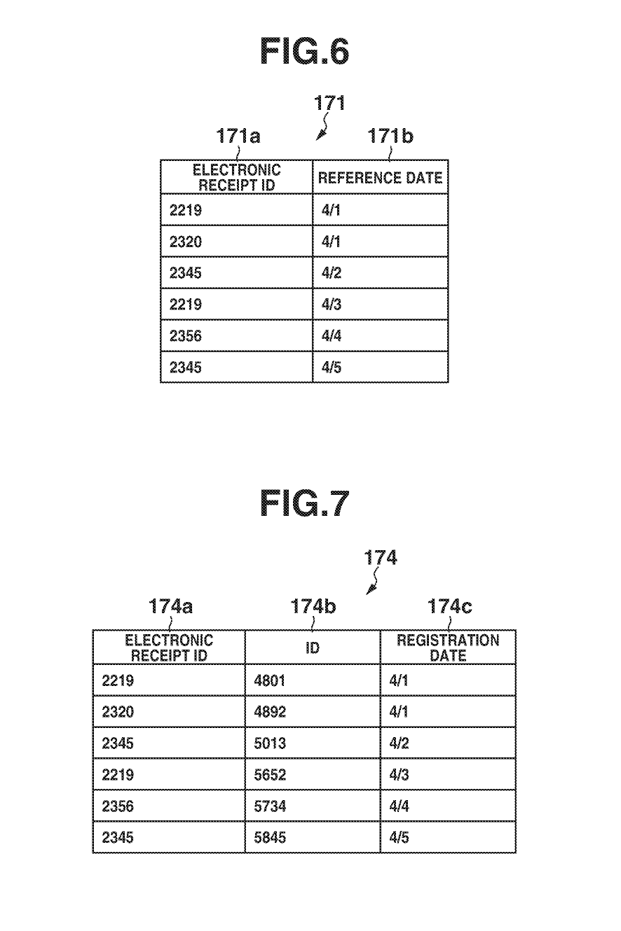

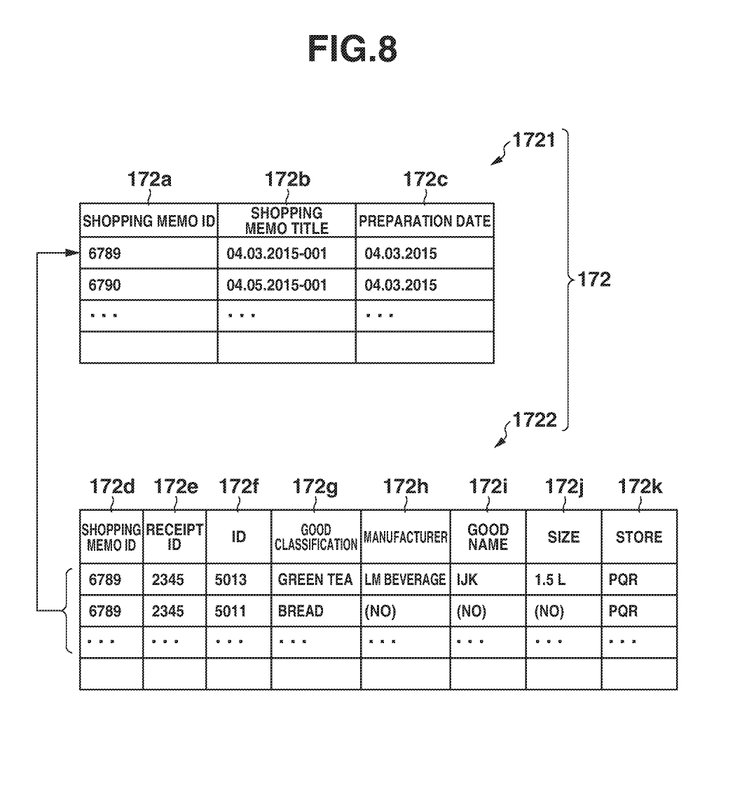

The electronic-receipt reference history 171 will be explained with reference to FIG. 6 later. The plural pieces of shopping-memo data 172 will be explained with reference to FIG. 8 later. And the shopping-list registration history will be explained with reference to FIG. 7 later.

The power source unit 18 serves to supply power to various parts of the smart phone 1.

In the memory unit 17 are installed a program relating to electronic receipts for browsing an electronic receipt on the touch panel 15 and a shopping-memo managing program. The program relating to electronic receipts is for the smart phone 1 to receive from the server 3 an electronic receipt which will be issued after a commercial trade is settled. The shopping-memo managing program is used, when a shipping memo is prepared and managed by the user of the smart phone 1. These programs can be downloaded into the memory unit 17, for example, through the network 8.

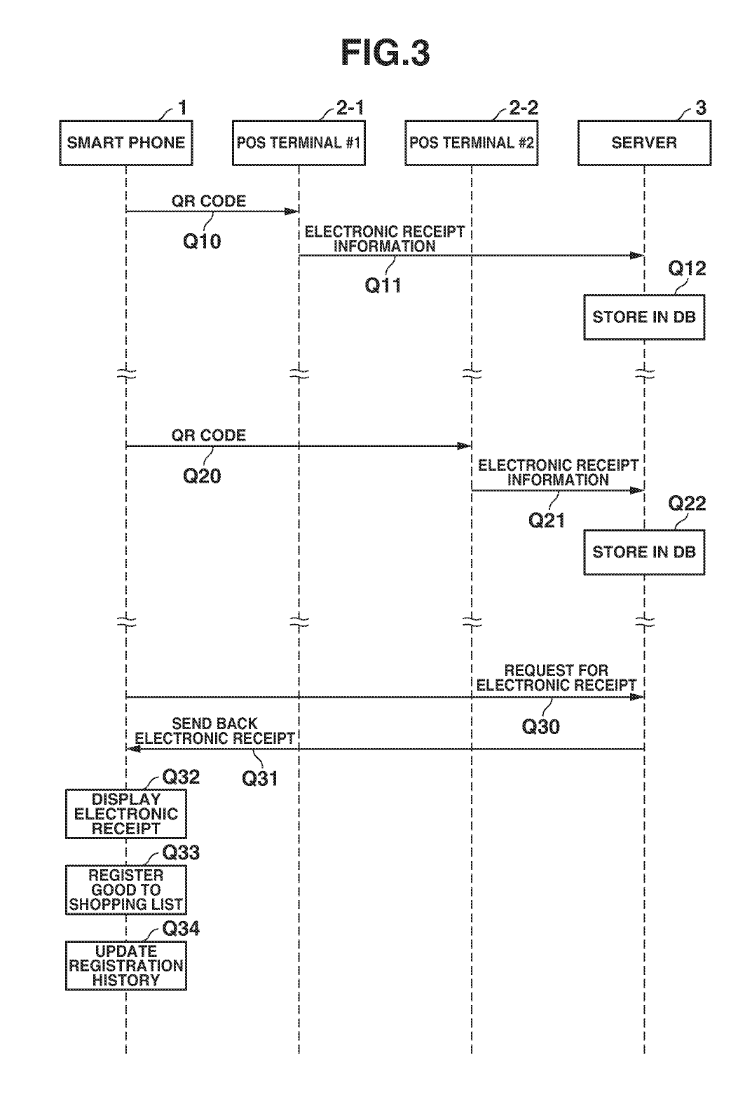

FIG. 3 is a view showing a sequence of processes for issuing an electronic receipt.

In FIG. 3, Sequences Q10 to Q12 represent a case, in which the user of the smart phone 1 has settled a commercial trade at a store, in which POS terminal 2-1 is installed.

The smart phone 1 displays QR Code (Registered Trademark) on the touch panel 15, making the POS terminal 2-1 recognize the identification information, when the commercial trade is settled (Sequence Q10).

The POS terminal 2-1 associates information of the electronic receipt relating to the commercial trade with the identification information of the smart phone 1 and sends it to the server 3 (Sequence Q11). The server 3 stores the information of the electronic receipt (hereinafter, the “electronic-receipt information”) associated with the identification information in the electronic receipt database 31 (Sequence Q12).

Sequences Q20 to Q22 represent a case, in which the user of the smart phone 1 has settled a commercial trade at another store, in which the POS terminal 2-2 is installed. The sequences Q20 to Q22 represent the case which is substantially the same as the case represented by the sequences Q10 to Q12.

Sequences Q30 to Q34 represent a case, in which the smart phone 1 downloads the electronic receipt, allowing the user to browse the electronic receipt.

The smart phone 1 sends the server 3 a request for reference to electronic-receipt information (Sequence Q30). At this time, the smart phone 1 demands the electronic-receipt information identified by the identification information of the smart phone 1.

The server 3 selectively sends back the smart phone 1 the electronic-receipt information identified by the identification information (Sequence Q31). The smart phone 1 displays the received electronic-receipt information on the touch panel 15 (Sequence Q32), and updates the electronic-receipt reference history 171 based on the received electronic-receipt information (Sequence Q33). When the goods on the electronic receipt are registered in the shopping memo (Sequence Q33), the smart phone 1 updates the shopping-list registration history 174 (Sequence Q34).

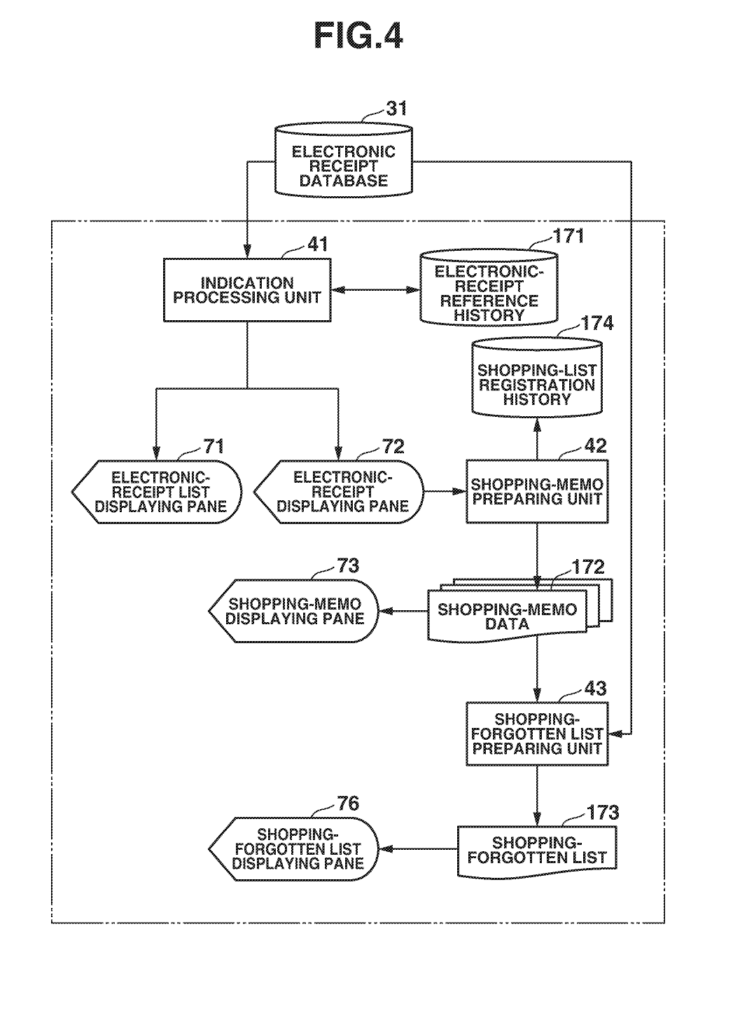

FIG. 4 is a view showing a logical composition of the electronic receipt system 9 according to the embodiment of the invention. In FIG. 4, various units embodied within the smart phone 1 are surrounded by a two-dot chain line.

When executed by CPU 11, the program stored in the smart phone 1 embodies an indication processing unit 41, shopping-memo preparing unit 42, and shopping-forgotten list preparing unit 43.

The indication processing unit 41 displays list-information of the electronic receipts sent from the electronic receipt database 31 in an electronic-receipt list displaying pane 71, and stores the list-information of the electronic receipts in the electronic-receipt reference history 171. The indication processing unit 41 further displays information of an electronic-receipt sent from the electronic receipt database 31 in an electronic-receipt displaying pane 72. The indication processing unit 41 indicates in the electronic-receipt displaying pane 72 in a distinguishable manner whether or not each piece of commodity information has been registered to the shopping list of the shopping memo prepared in the past by the shopping-memo preparing unit 42. Further, the indication processing unit 41 indicates in the electronic-receipt displaying pane 72 in a distinguishable manner whether or not each piece of commodity information has been registered to the shopping list in the shopping memo under preparation by the shopping-memo preparing unit 42. These indications in the electronic-receipt displaying pane 72 allow a customer to easily distinguish and choose the goods which were registered in the shopping list in the past.

The shopping-memo preparing unit 42 registers the commodity information indicated in the electronic-receipt displaying pane 72 to the shopping list in a shopping-memo displaying pane 73 to prepare a shopping memo. The shopping-memo preparing unit 42 records the commodity-information registered in the shopping list to the shopping-list registration history 174.

The shopping-remainder list preparing unit 43 compares a new electronic receipt with the shopping-memo data 172 to make a shopping-forgotten list 173, and displays the shopping-forgotten list 173 in a shopping-forgotten list displaying pane 76. Confirming the shopping-forgotten list 173 displayed in the shopping-forgotten list displaying pane 76, the customer can easily notice the goods that he/she has forgotten to buy.

FIG. 5 is a view showing the electronic receipt database 31 stored in the server 3.

The electronic receipt database 31 is a relational database consisting of an electronic-receipt list database 311 combined with a purchased good database 312, wherein the electronic-receipt list database 311 stores information concerning electronic receipts and the purchased good database 312 stores information representing purchased goods on the electronic receipts. The combination of the electronic-receipt list database 311 and the purchased good database 312 will allow it to display a list of electronic receipts (an electronic receipt list 714) easily and also to display the goods on the selected electronic receipt easily.

As shown in FIG. 5, the electronic-receipt list database 311 includes a receipt ID column 311a, customer ID column 311b, date and time column 311c, store column 311d, and sales clerk column 311e.

The receipt ID column 311a stores the identification information of the electronic receipt itself.

The customer ID column 311b stores the identification information of the customer, to which the electronic receipt is issued. It is possible to obtain the electronic receipts of the customer by searching for the identification information of the customer through the electronic-receipt list database 311.

The date and time column 311c stores a date and time, on which an electronic receipt has been issued. The store column 311d stores the name of a store which has issued the electronic receipt. The sales clerk column 311e stores the name of a sales clerk who has taken charge of the commercial trade concerning the electronic receipt.

The purchased good database 312 stores various sorts of information concerning the purchased goods. As shown in FIG. 5, the purchased good database 312 includes a receipt ID column 312a, ID column 312b, good-classification column 312c, manufacturer column 312d, good-name column 312e, size column 312f, and price column 312g.

The receipt ID column 312a stores the identification information of the electronic receipt concerning the purchased good. It is possible to obtain information of the goods indicated on the electronic receipt by searching for the identification information of the electronic receipt through the receipt ID column 312a.

The ID column 312b stores the identification information of the purchased good. The good-classification column 312c stores the good classification of the purchased good. The manufacturer column 312d stores the name of a manufacturer of the purchased good.

The good-name column 312e stores the name of the purchased good. The size column 312f stores information of a size of the purchased good. The price column 312g stores information of a sales price of the purchased good.

FIG. 6 is a view showing the electronic-receipt reference history 171 stored in the smart phone 1. The electronic-receipt reference history 171 stores a history in which a customer has referred to the electronic receipts. The electronic-receipt reference history 171 has an electronic receipt ID column 171a, and reference date column 171b.

The electronic receipt ID column 171a stores the identification information of the electronic receipt, to which the customer referred. The reference date column 171b stores a date on which the customer referred to the electronic receipt.

As described above, since the electronic receipt database 31 and the electronic-receipt reference history 171 are prepared separately, an update frequency of the electronic receipt database 31 is decreased and a load of the server 3 can be dispersed. Further, in the case where the smart phone 1 can update the electronic receipt database 31, inconsistency can be caused in data of the electronic receipt database 31 due to a failure of the smart phone 1. When the electronic receipt database 31 and the electronic-receipt reference history 171 are prepared separately and the smart phone 1 updates only the electronic-receipt reference history 171, the possibility of the inconsistency in data of the electronic receipt database 31 will be obviated.

FIG. 7 is a view showing the shopping-list registration history 174 stored in the smart phone 1. The shopping-list registration history 174 stores the history in which the customer registered the commodity-information indicated on an electronic receipt in the shopping list. The shopping-list registration history 174 includes an electronic receipt ID column 174a, ID column 174b, and registration date column 174c.

The electronic receipt ID column 174a stores the identification information of the electronic receipt whose commodity-information was registered in the shopping list by the customer.

The ID column 174b stores the identification information of the good which was registered in the shopping list by the customer. The registration date column 174c stores the date and time on which the customer registered the good in the shopping list.

As described above, since the electronic receipt database 31 and the shopping-list registration history 174 are prepared separately, the update frequency of the electronic receipt database 31 is decreased and the load of the server 3 can be dispersed. Further, in the case where the smart phone 1 can update the electronic receipt database 31, inconsistency can be caused in the data of the electronic receipt database 31 due to a failure of the smart phone 1. When the electronic receipt database 31 and the shopping-list registration history 174 are prepared separately, and the smart phone 1 updates only the shopping-list registration history 174, the possibility of the inconsistency in data of the electronic receipt database 31 will be obviated.

FIG. 8 is a view showing the shopping-memo data 172 stored in the smart phone 1.

The shopping-memo data 172 is a memorandum which is used by the customer to prevent from forgetting buying goods. The shopping-memo data 172 is prepared by selecting the goods from the electronic receipts. The shopping-memo data 172 is a relational database consisting of shopping-memo list data 1721 combined with shopping-memo good data 1722. The shopping-memo list data 1721 combined with the shopping-memo good data 1722 will allow it to display the list of shopping memos easily and also to display the goods on the selected shopping memo easily.

The shopping-memo list data 1721 includes a shopping memo ID column 172a, shopping memo title column 172b, and preparation date column 172c.

The shopping memo ID column 172a stores the identification information of a shopping memo. It is possible to obtain the goods to be included in a shopping memo by searching for the identification information of the shopping memo through the shopping-memo good data 1722.

The shopping memo title column 172b stores the title of the shopping memo, and stores a date and a serial number as default. The preparation date column 172c stores a date on which the shopping memo has been prepared.

The shopping-memo good data 1722 is data relating to the selected goods. The shopping-memo good data 1722 includes a shopping memo ID column 172d, receipt ID column 172e, ID column 172f, good-classification column 172g, manufacturer column 172h, good-name column 172i, size column 172j, and store column 172k.

The shopping memo ID column 172d stores the identification information of the shopping memo. The receipt ID column 172e stores the identification information of the electronic receipt from which the good is selected.

The ID column 172f stores the identification information of the selected good. The good-classification column 172g stores a good classification of the selected good. The manufacturer column 172h stores the name of a manufacturer/seller of the selected good. The good-name column 172i stores the name of the selected good. The size column 172j store a size of the selected good. The store column 172k stores the name of the store in which the customer bought the selected good.

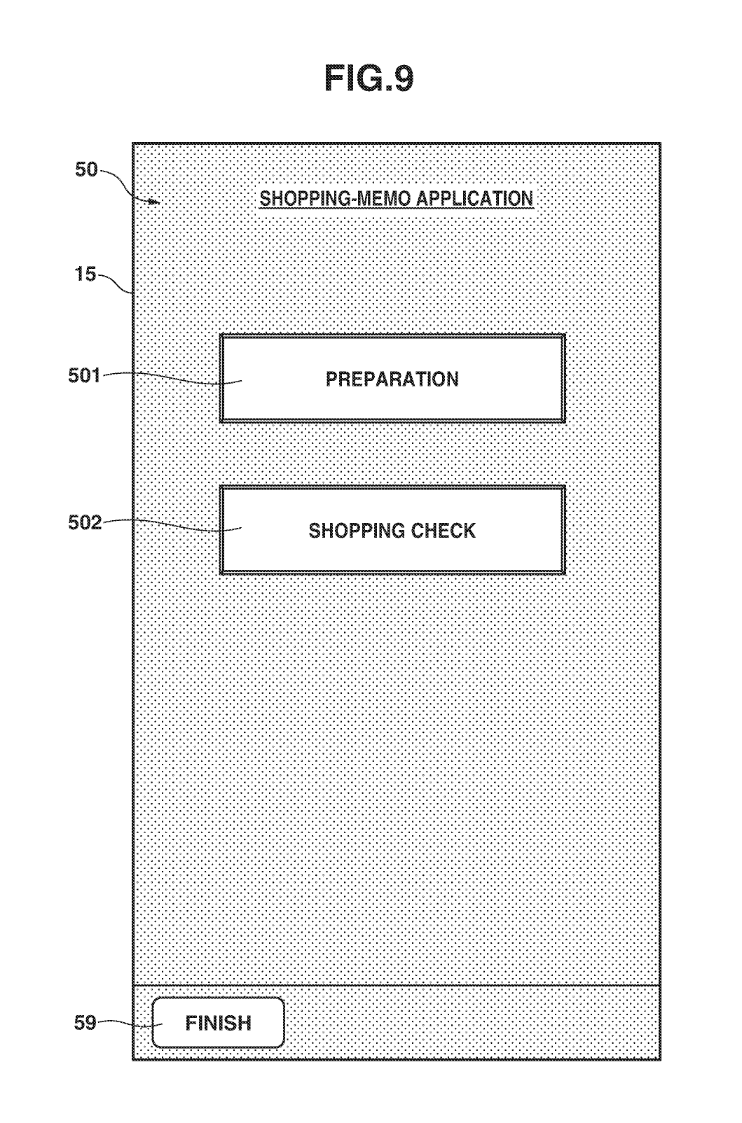

FIG. 9 is a view showing an initial screen 50 displayed by an application program of a shopping memorandum (Hereinafter, the “shopping-memo application program”).

When the shopping-memo application program starts, the initial screen 50 is displayed on the touch panel 15 of the smart phone 1. The initial screen 50 has a new memo preparation button 501 and shopping check button 502. At the bottom of the initial screen 50, a finish button 59 is indicated. When the finish button is tapped, the running application program finishes. The finish button 59 has the same function independently of the screens in which said button 59 is included.

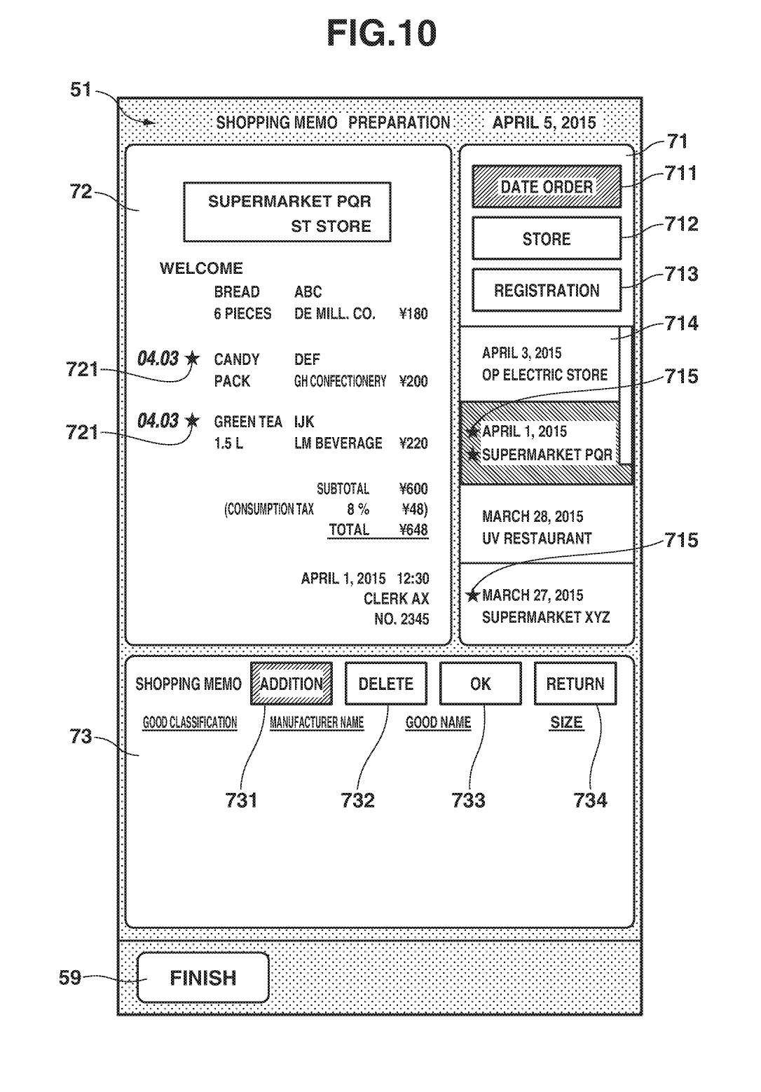

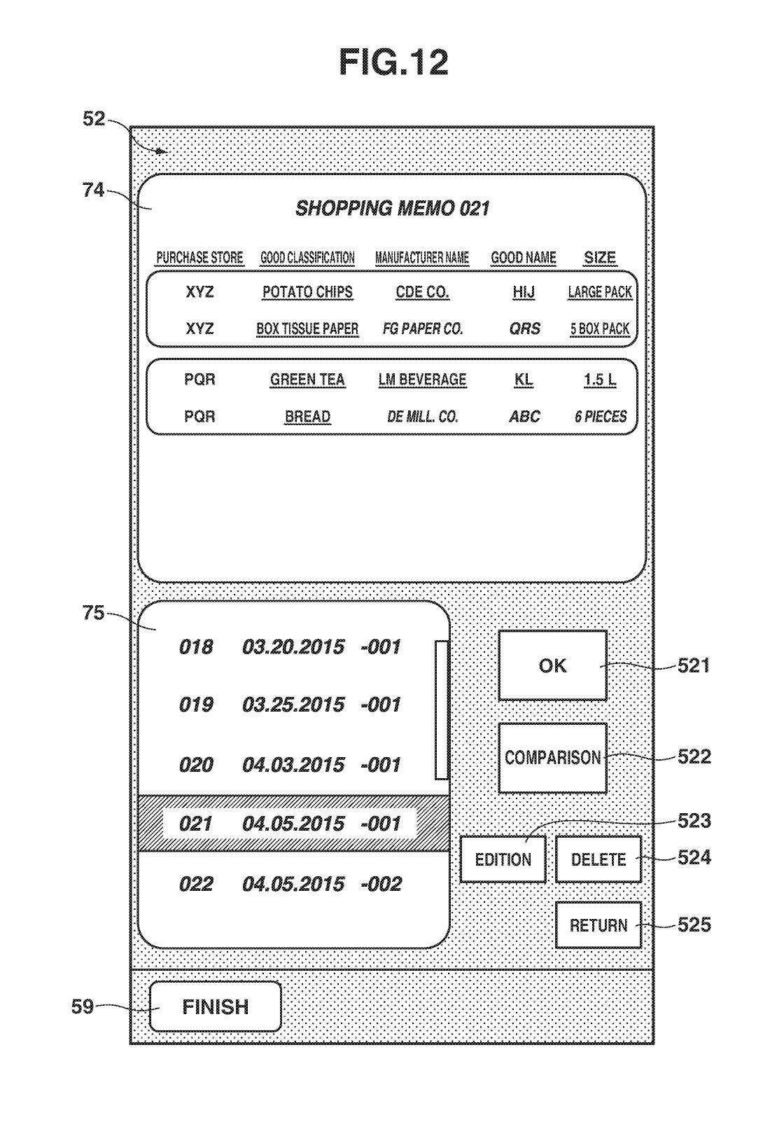

The new memo preparation button 501 is used to transit to a screen 51 (FIG. 10) for preparing a new shopping memo (Hereinafter, the “new shopping-memo preparing screen” 51). The shopping check button 502 is used to transit to a shopping check screen 52 (FIG. 12). When the shopping check button 502 is tapped, the initial screen 50 transits to the shopping check screen 52, allowing the user to confirm if there is left any good that has not yet been bought.

FIG. 10 is a view showing an initial state of the new shopping-memo preparing screen 51 displayed by the shopping-memo application program.

The new shopping-memo preparing screen 51 is used to prepare a new shopping memo, and has an electronic-receipt list displaying pane 71, electronic-receipt displaying pane 72, the shopping-memo displaying pane 73, and finish button 59.

The electronic-receipt list displaying pane 71 is a pane for displaying electronic receipt in a list format, and includes a date order button 711, store button 712, and registration button 713, and displays a list 714 of electronic receipts at the lower part of these buttons. The electronic receipt list 714 can be scrolled up and down with a horizontal sliding operation. In the electronic-receipt list displaying pane 71 of FIG. 10, a scrolling bar is shown. In the electronic receipt list 714, the number of registrations of the electronic receipt to the shopping list is indicated by the number and/or the size of a registration mark 715 in a discriminable manner. In the electronic receipt list 714 shown in FIG. 10, for instance, two registration marks 715 are attached to the electronic receipt of PQR Supermarket Apr. 1, 2015, which indicates that this electronic receipt was registered to the shopping list two times in the past.

The date order button 711 is used to rearrange and display the electronic receipts in the electronic receipt list 714 in order of dates. The rearranged electronic receipts allow the customer to easily refer to the latest electronic receipt. The store button 712 is used to rearrange and display the electronic receipts of stores in the electronic receipt list 714 in order of stores. The rearranged electronic receipts allow the customer to easily refer to the electronic receipt of the desired store.

The registration button 713 is used to rearrange and display the electronic receipts in the electronic receipt list 714 in order of the number of registrations to the shopping list. The rearranged electronic receipts allow the customer to easily refer to the electronic receipt which has been registered to the shopping list most frequently. The customer is used to repeatedly refer to the electronic receipt which has been registered most frequently to prepare shopping lists.

The electronic-receipt displaying pane 72 is a pane for displaying contents of an electronic receipt, and displays the contents of the electronic receipt selected in the electronic-receipt list displaying pane 71 by the customer. In the electronic-receipt displaying pane 72 are indicated a store name, purchased goods, sizes or amount, purchased prices, subtotals, consumption tax, total, date, and sales clerk. The customer is allowed to select the goods indicated in the electronic-receipt displaying pane 72 by tapping them and also to scroll the good list up and/or down by a vertical sliding operation on the pane 72.

On the electronic receipt, an existing registration mark 721 is indicated next to the good which was registered when the another shopping list was made in the past. In the vicinity of the existing registration mark 721, a date on which the good was registered to the shopping list is indicated.

Paying attention to the good with the existing registration mark 721 attached, the customer can prepare a shopping memo effectively. Further, the indicated date on which the good was registered to the shopping list is useful for the customer to judge whether or not it is necessary to purchase the good again, if said good is an expandable, whereby the shopping memo can be prepared in a simple manner on a dairy basis.

The shopping-memo displaying pane 73 is a pane for displaying the shopping list composing a shopping memo, and has the shopping list, an addition button 731, delete button 732, OK button 733, and return button 734. The customer is allowed to select the goods in the shopping list registered to the shopping-memo displaying pane 73 by tapping operation thereon, and the shopping list can be scrolled up and down with a vertical sliding operation on the pane 73.

The addition button 731 is used to add commodity-information on an electronic receipt to the present shopping list. When tapped, the addition button 731 is turned on, representing that an addition mode has been set. When commodity-information on the electronic receipt is tapped with the addition button 731 turned on, the commodity-information is added to the shopping list. When tapped again, the addition button 731 is turned off and the addition mode finishes. Even if commodity-information on the electronic receipt is double-tapped with the button other than the addition button 731 turned on, the commodity-information will be added to the shopping list. Further, even if a good name on the electronic receipt is dragged to the shopping list, the good will be added to the shopping list. The arrangement of the addition button 731 is not restricted to the above, but re-arrangement will be possible such that the customer is allowed to tap the commodity-information of the electronic receipt and then to tap the addition button 731, thereby adding the commodity-information to the shopping list.

The delete button 732 is used to delete the commodity-information from the present shopping list. When tapped, the delete button 732 is turned on, representing that a delete mode has been set. When commodity-information on the shopping list is tapped with the delete button 732 turned on, the commodity-information is deleted from the shopping list. When tapped again, the delete button 732 is turned off and the delete mode will finish.

When the delete button 732 is tapped with the addition button 731 turned on, then the addition button 731 will be turned off and the delete button 732 will be turned off. When the addition button 731 is tapped with the delete button 732 turned on, then the delete button 732 will be turned off and the addition button 731 will be turned off.

The arrangement of the delete button 732 is not restricted to the above, but re-arrangement will be possible such that the customer is allowed to tap the commodity-information of the shopping list and then to tap the delete button 732, thereby deleting the commodity-information from the shopping list.

The OK button 733 is used when the contents of the shopping memo the customer is preparing are decided. When the OK button 733 is tapped, the new shopping-memo preparing screen 51 returns to the initial screen 50 shown in FIG. 9. The return button 734 is used to cancel operation performed on the shopping memo and to return to the initial screen 50 shown in FIG. 9.

Since the customer prepares the shopping memo by tapping to select commodity-information on the electronic receipt and is not required to enter the commodity-information one by one, the shopping memo can be prepared more easily.

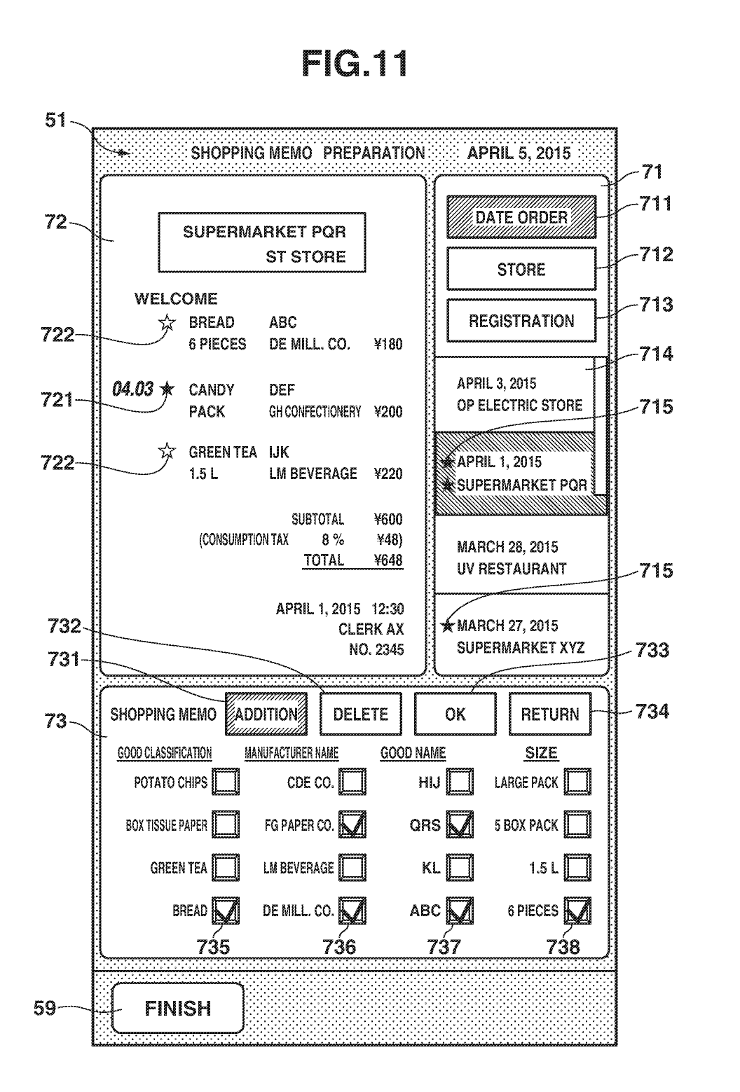

FIG. 11 is a view showing a procedure of registering a good to the good list of the new shopping-memo preparing screen 51 displayed by the shopping-memo application program.

In the electronic-receipt displaying pane 72 of the new shopping-memo preparing screen 51 to which goods have been registered, a newly registered mark 722 is added to the good which has been registered to the shopping list, representing that said good is newly registered to the shopping list. For example, when the OK button 733 is tapped, the newly registered mark 722 is turned to the existing registration mark 721.

In the shopping-memo displaying pane 73 shown in FIG. 11, 4 pieces of commodity-information are registered in the shopping list. Each piece of commodity-information has the good classification, name of a manufacturer, good name, and size. In addition to these items, any information such as a commodity price can be added.

A good-classification check box 735 is used to give advice of purchasing goods falling in a similar good classification regardless of the corresponding specific good. In the present embodiment, the goods falling in the similar good classification are those falling in the same good classification on the electronic receipt. For example, the good-classification check box 735 for “bread” is checked in FIG. 11. This means that the customer can purchase arbitrary sorts of bread. In other words, the customer can purchase any bread, not sticking to the name of the manufacturer, the good name, and the size. Therefore, when the good-classification check box 735 is checked, a manufacturer name check box 736, good name check box 737, and size check box 738 are automatically checked.

The manufacturer name check box 736 indicates that the customer is allowed to purchase any good regardless of the name of the manufacturer. For example, the manufacturer name check box 736 for “box tissue paper” is checked in FIG. 11. This means that the customer is allowed to purchase any “box tissue paper” regardless of “FG manufacturer” made tissue paper. Further, this means that the customer can purchase any “box tissue paper” regardless of the good name. Therefore, when the manufacturer name check box 736 is checked, the good name check box 737 is checked automatically.

The good name check box 737 indicates that the customer is allowed to purchase any good regardless of the good name. The size check box 738 indicates that the customer is allowed to purchase any good regardless of its size. As described above, specifying information irrespective of personal desire, the customer can compare the shopping list with the electronic receipt appropriately, whereby a shopping-forgotten list 173 which meets with the customer's desire can be prepared. That is, a level of coincidence between the shopping memo and the electronic receipt issued after shopping can be set.

FIG. 12 is a view showing the shopping check screen 52 displayed by the shopping-memo application program.

The shopping check screen 52 includes a shopping-memo displaying pane 74 and shopping-memo list displaying pane 75, and further has an OK button 521, comparison button 522, edition button 523, delete button 524, return button 525, and the finish button 59.

The shopping-memo displaying pane 74 indicates a shopping list including information of a purchase store, good classification, name of a manufacturer, and size. In the shopping list, the information on which the customer fixates is indicated in bold font with an underline, and the information on which the customer does not fixate is indicated in italic font. In other words, in the shopping list the information on which the customer fixates is indicated to be easily discriminated from the information on which the customer does not fixate, whereby the customer can easily understand the range of goods to select for shopping. It will be better to indicate the information on which the customer does not fixate inconspicuously, for example, in grey color, and to indicate the information on which the customer does not fixate conspicuously, for example, in bold font, whereby the customer can do shopping appropriately according to the indicated list information.

In the shopping-memo displaying pane 74 shown in FIG. 12, the potato chips and green tea (good classification) are indicated in bold font with an underline in their manufacturer columns, good-name columns, and size columns. From these indications the customer easily understands that he/she should buy the potato chips “HIJ” (good name) of CDE Co. made (manufacturer), big size, and the green tea “KL” (good name) of LM co. (manufacturer), 1.5 lit size.

The box tissue paper (good classification) is indicated with the bold fonts with an underline only in the size column. Then, the customer learns that he/she should buy the box tissue paper of 5 packs regardless of the manufacturer and good name. The bread (good classification) is indicated with the italic fonts in the name of manufacturer column, good name column and size column. Then, the customer learns that he/she can buy the bread without paying no attention to the name of manufacturer, good name, and size.

The shopping-memo displaying pane 74 can be scrolled up and down by a vertical sliding operation thereon. The shopping lists are grouped by store. Therefore, the customer can easily decide at which store he/she should do shopping.

The shopping-memo list displaying pane 75 lists the shopping memos that were prepared in the past, and the shopping-memo displaying pane 74 displays the shopping memo that the customer selected. In FIG. 12, the shopping-memo displaying pane 74 displays the shopping memo of No. 021, 2015. 04. 05, selected by the customer.

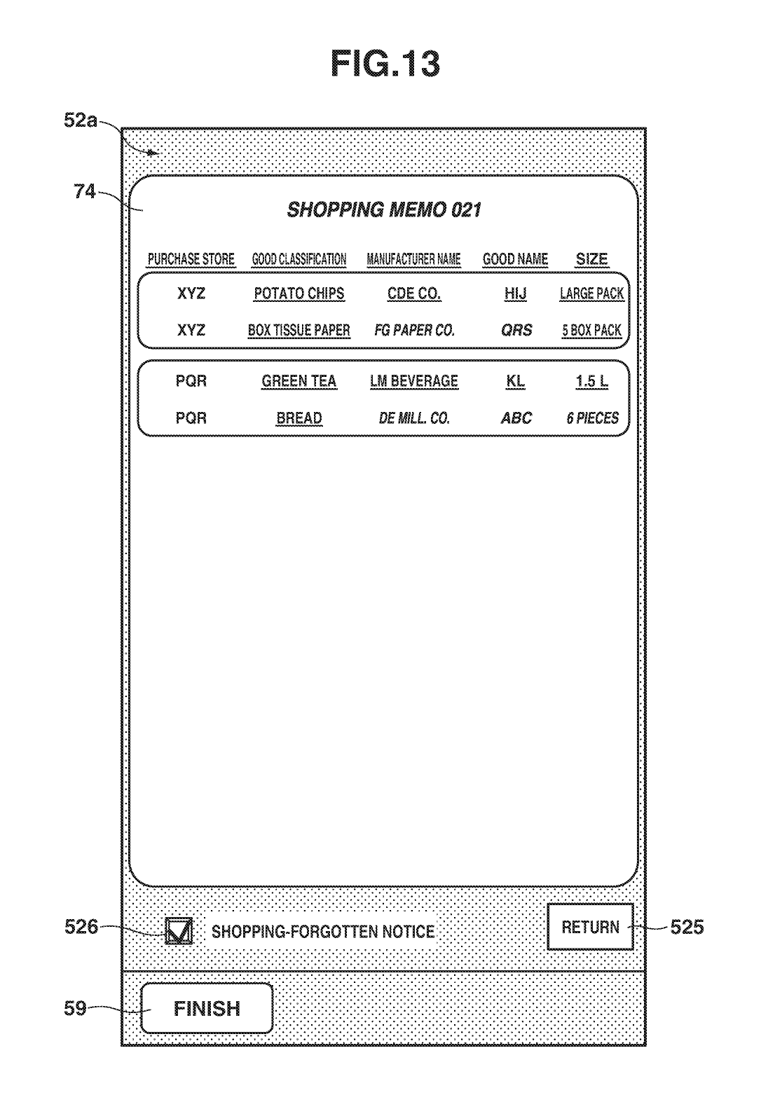

The OK button 521 is used to decide the shopping memo displayed in the shopping-memo displaying pane 74 as a new shopping memo. When the OK button 521 is tapped, the shopping check screen 52 (FIG. 12) transits to a shopping memo screen 52a (FIG. 13). The shopping-memo list displaying pane 75 can be scrolled up and down by a vertical sliding operation thereon. The shopping memo on the shopping-memo list displaying pane 75 can be selected and displayed on the shopping-memo displaying pane 74 by tapping the shopping memo.

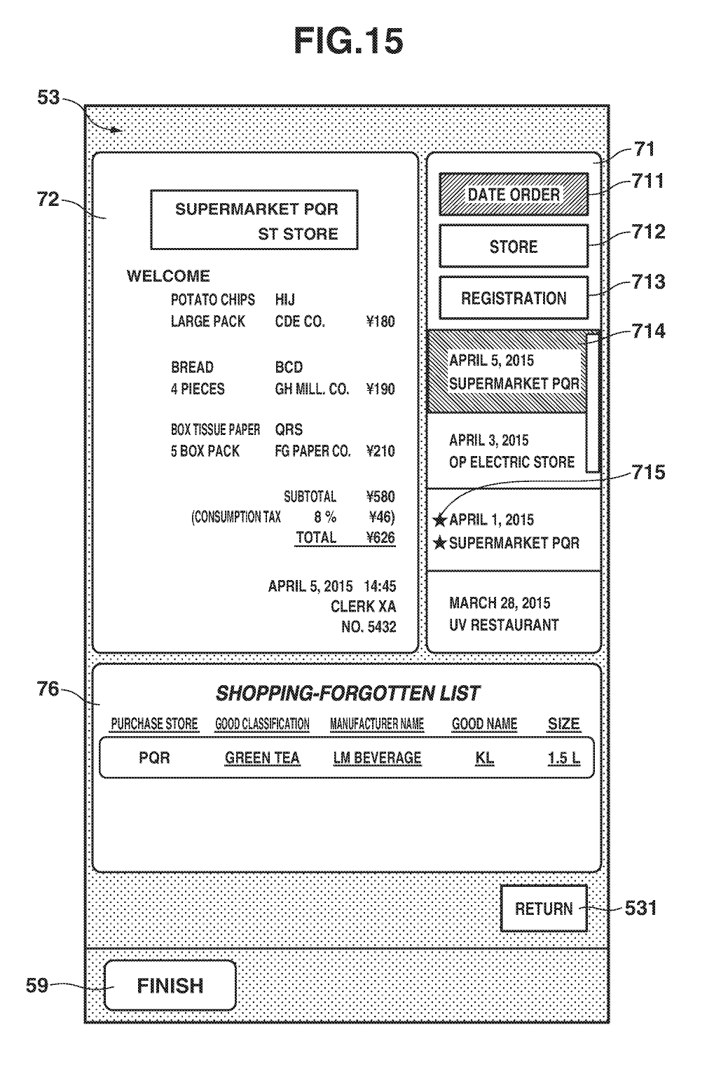

The comparison button 522 is used to compare the shopping memo displayed in the shopping-memo displaying pane 74 with an electronic receipt to prepare a shopping-forgotten list 173. When the comparison button 522 is tapped, the shopping check screen 52 (FIG. 12) transits to a shopping-forgotten list screen 53 (FIG. 15).

The edition button 523 is used to edit the shopping memo displayed in the shopping-memo displaying pane 74. When the edition button 523 is tapped, the shopping check screen 52 (FIG. 12) transits to an edition screen 53 with nothing displayed.

The delete button 524 is used to delete the shopping memo displayed in the shopping-memo displaying pane 74. The return button 525 is used to return to the initial screen 50 shown in FIG. 9.

FIG. 13 is a view showing the shopping memo screen 52a displayed by the shopping-memo application program.

On the shopping memo screen 52a, the shopping-memo displaying pane 74 is displayed in a large size, and a check box 526 for giving notice of preventing from forgetting to buy and a return box 525 are indicated at the bottom of the screen 52a. The customer does shopping, watching the shopping memo screen 52a.

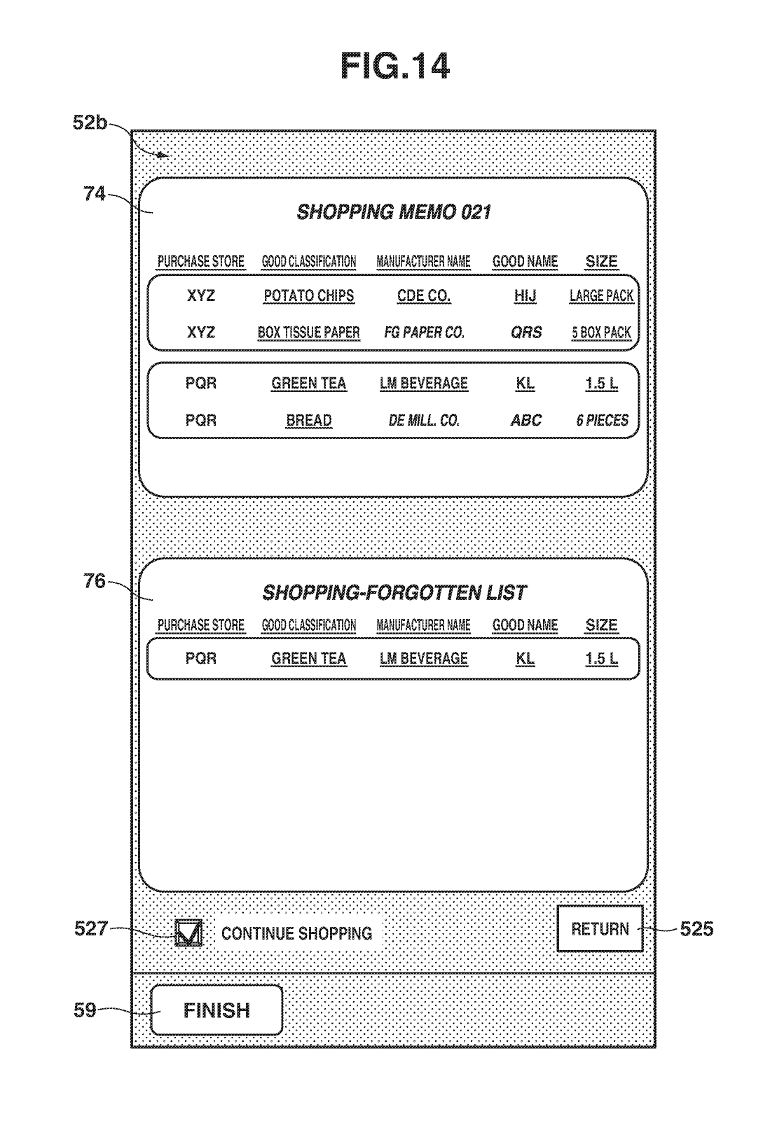

Every time a new electronic receipt is received, the check box 526 displays notice of shopping reminder. The check box 526 is held checked as default. When a new electronic receipt is received with the check box 526 checked, the shopping-forgotten list 173 is updated with the received electronic receipt, and the shopping memo screen 52a transits to a shopping-memo comparing screen 52b (FIG. 14). The smart phone 1 of the present embodiment watches the electronic-receipt list database 311 of the server 3 at all times. When detecting that a new electronic receipt has been registered, the smart phone 1 receives the electronic receipt.

The return button 525 is used to return from the shopping memo screen 52a to the prior screen. When the return button 525 is tapped, the shopping memo screen 52a (FIG. 13) transits to the shopping check screen 52 (FIG. 12).

FIG. 14 is a view showing the shopping-memo comparing screen 52b displayed by the shopping-memo application program.

The shopping-memo displaying pane 74 and shopping-forgotten list displaying pane 76 are displayed on the shopping-memo comparing screen 52b, and a shopping continue check box 527 and the return button 525 are provided at the bottom of the shopping-memo comparing screen 52b.

In the shopping-forgotten list displaying pane 76, a result of comparison of a new electronic receipt with the shopping memo is displayed as a shopping-forgotten list. The shopping-forgotten list displaying pane 76 can be scrolled up and down by a vertical sliding operation thereon. The customer can easily confirm whether or not any good he/she forgets buy is left, based on the shopping memo and shopping-forgotten list indicated on the shopping-memo comparing screen 52b.

The shopping continue check box 527 is used to indicate whether the customer will continue further shopping or not. The check box 527 is held checked as default. When shopping continue check box 527 is checked, the shopping list is updated and displayed every time a new electronic receipt is received. The customer can easily confirm that there is left no good he/she forgets to buy, even thought he/she did shopping at plural stores or plural times separately at a store.

The return button 525 is used to return from the shopping-memo comparing screen 52b to the prior screen. When the return button 525 is tapped, the shopping-memo comparing screen 52b (FIG. 14) transits to the shopping memo screen 52a (FIG. 13).

FIG. 15 is a view showing the shopping-forgotten list screen 53 displayed by the shopping-memo application program. In FIG. 15, like elements as those in the new shopping-memo preparing screen 51 shown in FIG. 10 are designated by like reference numerals and their description is omitted there.

The shopping-forgotten list screen 53 indicates a list of goods that the customer forgot to buy, includes the electronic-receipt list displaying pane 71 and electronic-receipt displaying pane 72, like as shown in FIG. 10, and further includes a shopping-forgotten list displaying pane 76 and the finish button 59.

The electronic-receipt list displaying pane 71 shows that an electronic receipt of PQR Supermarket, Apr. 5, 2015 is selected. The smart phone 1 compares the electronic receipt and shopping memo to display a list of goods that the customer forgot to buy (Hereinafter, the “shopping-forgotten list”).

In the electronic-receipt displaying pane 72, the contents of the selected electronic receipt are indicated.

In the shopping-forgotten list displaying pane 76, the shopping-forgotten list is indicated, that is, a result of comparison of the electronic receipt with the shopping memo is indicated. The shopping-forgotten list displaying pane 76 shown in FIG. 15 indicates the green tea forgotten to be bought. It is also indicated that the green tea is “KL” (good name), LM co. made, 1.5 lit size, and the customer bought it at PQR Supermarket in the past.

The return button 525 is used to return from the shopping-forgotten list screen 53 to the prior screen. When the return button 525 is tapped, the shopping-forgotten list screen 53 transits to the shopping memo screen 52a (FIG. 13).

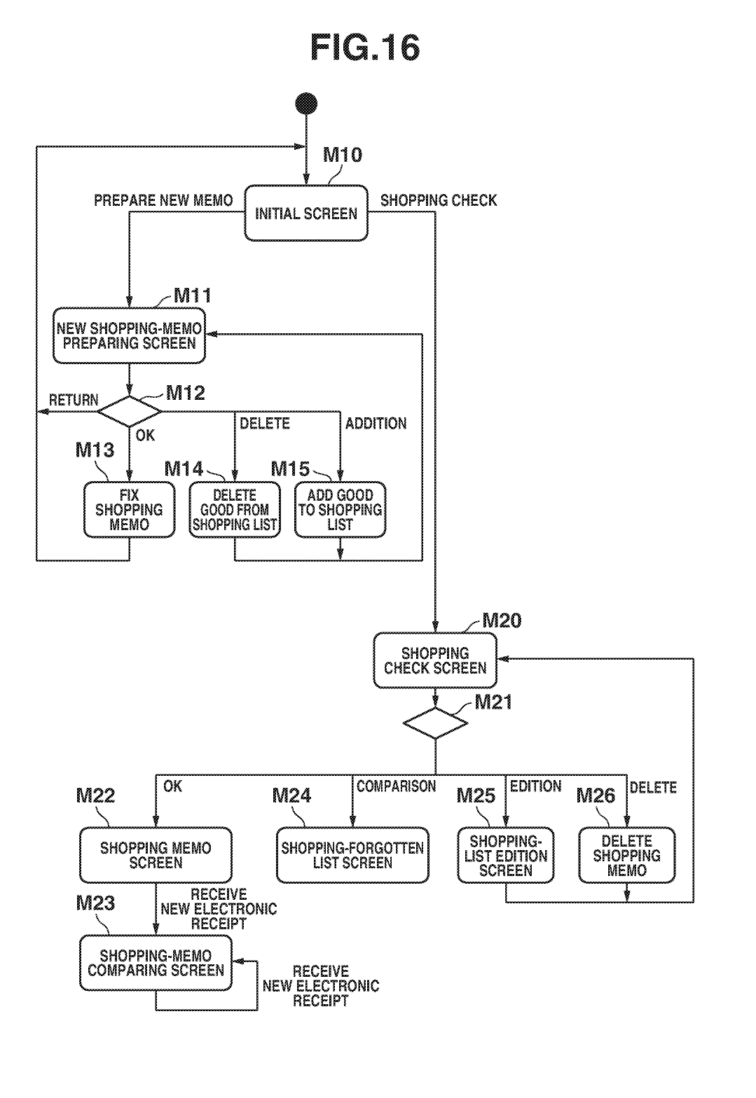

FIG. 16 is a view showing a mode transition of the shopping-memo application program.

When the customer starts the shopping-memo application program, the smart phone 1 is set to a mode M10 (Mode M10).

When the new memo preparation button 501 on the initial screen 50 (FIG. 9) is tapped in the mode M10, the initial screen 50 of Mode M10 (FIG. 9) transits to the new shopping-memo preparing screen 51 of Mode M11 (FIG. 10). When the shopping check button 502 on the initial screen 50 (FIG. 9) is tapped, the initial screen 50 (FIG. 9) transits to the shopping check screen 52 of Mode M20 (FIG. 12).

In the mode M12, it is judged whether an input operation has been performed on the new shopping-memo preparing screen 51 (FIG. 10). When it is detected that the OK button 733 has been operated (Mode M12), the shopping memo is fixed (Mode M13) and the new shopping-memo preparing screen 51 of Mode M11 (FIG. 10) returns to the initial screen 50 of Mode M10 (FIG. 9), whereby the shopping memo under preparation is stored in the memory unit 17.

When it is detected that the return button 734 on the new shopping-memo preparing screen 51 (FIG. 10) has been operated (Mode M12), the new shopping-memo preparing screen 51 directly returns to the initial screen 50 of Mode M10 (FIG. 9), whereby the shopping memo under preparation is deleted.

When it is detected that the delete button 732 on the new shopping-memo preparing screen 51 (FIG. 10) has been operated (Mode M12), a good selected in the shopping memo is deleted (Mode M14) and the new shopping-memo preparing screen 51 of Mode M11 (FIG. 10) is displayed again. The good can be selected by tapping the corresponding commodity-information in the shopping memo.

When it is detected that the addition button 731 on the new shopping-memo preparing screen 51 (FIG. 10) has been operated (Mode M12), a good selected on the electronic receipt is added to the shopping list (Mode M15) and the new shopping-memo preparing screen 51 of Mode M11 (FIG. 10) is displayed again. The good can be selected by tapping the corresponding commodity-information on the electronic receipt.

In the mode M21, it is judged whether an input operation has been performed on the shopping check screen 52 of Mode M20 (FIG. 12). When it is detected that the OK button 521 has been operated (Mode M21), the shopping check screen 52 of Mode M20 (FIG. 12) transits to the shopping memo screen 52a of Mode M22 (FIG. 13). When the smart phone 1 receives a new electronic receipt in Mode M22, the shopping memo screen 52a of Mode M22 (FIG. 13) transits to the shopping-memo comparing screen 52b of Mode M23 (FIG. 14). When the smart phone 1 receives a new electronic receipt in Mode M23, the smart phone 1 repeatedly displays the shopping-memo comparing screen 52b of Mode M23 (FIG. 14).

When it is detected in the mode M21 that the comparison button 522 has been operated, the shopping check screen 52 of Mode M20 (FIG. 12) transits to the shopping-forgotten list screen 53 of Mode M24 (FIG. 15).

When it is detected in the mode M21 that the edition button 523 has been operated, the shopping check screen 52 of Mode M20 (FIG. 12) transits to a shopping-list edition screen (not shown) of Mode M25, and then returns to the shopping check screen 52 of Mode M20 (FIG. 12).

When it is detected in the mode M21 that the delete button 524 has been operated, the selected shopping memo is deleted (Mode M26), and the smart phone 1 displays the shopping check screen 52 of Mode M20 (FIG. 12), again.

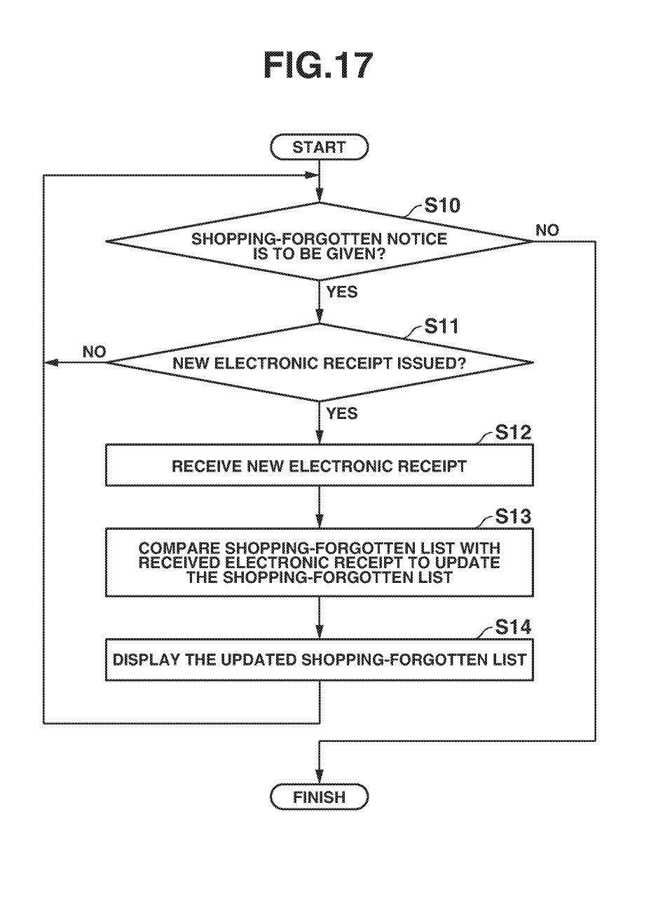

FIG. 17 is a flow chart of a process of updating the shopping-forgotten list.

For instance, when the customer moves around plural stores to do shopping while watching the shopping memo (shown in FIG. 13) in order not to forget to buy necessary goods, the process of updating the shopping-forgotten list is performed.

The shopping-forgotten list preparing unit 43 (FIG. 4) performs the process of updating the shopping-forgotten list to display the shopping-forgotten list displaying pane 76 (FIG. 14).

The shopping-forgotten list preparing unit 43 refers to the check box 526 (FIG. 13) or shopping continue check box 527 (FIG. 14) to determine whether a shopping-forgotten notice should be given or not (step S10 in FIG. 17). When the shopping-forgotten list preparing unit 43 determines that the shopping-forgotten notice is not given (NO at step S10), the process of FIG. 17 finishes.

When it is determined that the shopping-forgotten notice is given (YES at step S10), then the shopping-forgotten list preparing unit 43 judges whether a new electronic receipt has been issued (step S11). At this time, when the customer does another shopping at another store, a new electronic receipt will be issued.

When a new electronic receipt has not been issued (NO at step S11), the shopping-forgotten list preparing unit 43 returns to the process of step S10. When a new electronic receipt has been issued (YES at step S11), the shopping-forgotten list preparing unit 43 receives the new electronic receipt (step S12). At this time, the customer does another shopping.

The shopping-forgotten list preparing unit 43 compares the shopping-forgotten list with the received electronic receipt to update the shopping-forgotten list (step S13), and displays the updated shopping-forgotten list in the shopping-forgotten list displaying pane 76 (step S14), and then returns to the process of step S10. In other words, the shopping-forgotten list preparing unit 43 compares the electronic receipt of the new shopping with the shopping-forgotten list and updates the shopping-forgotten list, and displays the updated shopping-forgotten list.

More specifically, the shopping-forgotten list preparing unit 43 prepares the shopping-forgotten list and then compares commodity-information indicated on a newly received electronic receipt with the prepared shopping-forgotten list to prepare a new shopping-forgotten list. When the goods satisfying the information on which the customer fixates are included in the newly received electronic receipt, the shopping-forgotten list preparing unit 43 removes such goods from the new shopping-forgotten list. In this way, the prepared shopping memo and an electronic receipt or plural receipts issued after shopping are compared, and the customer is given notice of shopping-forgotten good(s). When the customer has purchased a substitute for the good which has been registered in the shopping memo, the good is removed from the shopping-forgotten list on the assumption that such good has been purchased, whereby the shopping list is maintained easy for daily use.

Although specific embodiments of the invention have been described in the foregoing detailed description, it will be understood that the invention is not limited to the particular embodiments described herein, but modifications and rearrangements may be made to the disclosed embodiments while remaining within the scope of the invention as defined by the following claims. It is intended to include the following modifications and rearrangements (a) to (h) in the claims and their equivalents:

(a) It is possible for the smart phone 1 to show around the store to display shelves of goods based on the prepared shopping memo and good-layout information of the store;
(b) When the customer does not fixate on a particular good classification, it is possible for the smart phone 1 to perform the comparison process by referring to the goods falling in a similar good classification in the database. In this case, even though the good classification managed on the electronic receipt deviates from the good classification the customer has in mind, it is possible to prepare a shopping-forgotten list which will satisfy the good classification the customer has in mind;
(c) In the embodiments of the invention described in the above description, the customer is asked on the shopping list to check the information on which he/she does not fixate, but on the contrary, it is possible to ask the customer to check the information on which he/she fixates;
(d) The existing registration mark 721 is used to indicate it in the electronic-receipt displaying pane 72 in a distinguishable manner, whether or not each piece of commodity information has been registered to the shopping list in the shopping memo prepared in the past. But the past registration to the shopping list can be indicated in various colors, fonts, font size, underlines, and combination of them;
(e) In the embodiments of the invention, the electronic receipts are rearranged and displayed in the electronic receipt list 714 in order of the number of registrations to the shopping list, but it is possible to display the electronic receipts in order of the reference history and also from the latest one based on the dates of the electronic receipts;
(f) In the embodiments of the invention, the shopping-memo application program is installed on the smart phone 1, but it is possible to install Web service of the shopping memo on the server 3 and to make the smart phone 1 receive the Web service. The configuration of system is not restricted to the embodiments described in the above description;
(g) In the embodiments of the invention, the smart phone 1 receives the electronic receipt from the POS terminal 2 through the electronic receipt database 31 of the server 3, but it is possible for the smart phone 1 to receive the electronic receipt directly from the POS terminal 2 through communication means such as a short-distance wireless communication; and
(h) In the embodiments of the invention, the smart phone 1 receives the electronic receipt and compares the received electronic receipt with the shopping memo to prepare the shopping-forgotten list, but mobile terminals such as tablet terminals and laptop computers may be used in place of the smart phone 1.

What is claimed is:

1. A shopping supporting apparatus comprising:
a shopping memo preparing unit which registers commodity information indicated on an electronic receipt in a shopping list in response to a user's operation to prepare a shopping memo; and
an indication processing unit which displays the electronic receipt that indicates in a distinguishable manner whether or not each piece of commodity information has been registered in the shopping list of the shopping memo that was prepared in the past by the shopping memo preparing unit.

2. The shopping supporting apparatus according to claim 1, wherein
the indication processing unit displays the electronic receipt that indicates in a distinguishable manner whether or not each piece of commodity information has been registered in the shopping list of the shopping memo which is under preparation.

3. The shopping supporting apparatus according to claim 1, further comprising:
a shopping-forgotten list preparing unit which compares commodity information indicated on an electronic receipt that is received after having prepared the shopping memo with the commodity information registered in the shopping list of said prepared shopping memo to prepare a shopping-forgotten list representing goods forgotten to buy.

4. The shopping supporting apparatus according to claim 3, wherein
the shopping-forgotten list preparing unit compares commodity information indicated on an electronic receipt that is received after having prepared the shopping-forgotten list with said prepared shopping-forgotten list to prepare a new shopping-forgotten list.

5. The shopping supporting apparatus according to claim 1, wherein
the indication processing unit lists and displays the electronic receipts in order of registrations of respective pieces of commodity information indicated on the electronic receipts to the shopping list.

6. The shopping supporting apparatus according to claim 1, wherein
the indication processing unit lists and displays the electronic receipts which indicate the number of registrations of commodity information written on the electronic receipts to the shopping list in a distinguishable manner.

7. A shopping supporting method comprising:
a shopping memo preparing step of registering commodity information indicated on an electronic receipt in a shopping list in response to a user's operation to prepare a shopping memo; and
an indication processing step of displaying the electronic receipt that indicates in a distinguishable manner whether or not each piece of commodity information has been registered in the shopping list of the shopping memo that was prepared in the past at the shopping memo preparing step.

8. The shopping supporting method according to claim 7, wherein
at the indication processing step, the electronic receipt is displayed so as to indicate in a distinguishable manner whether or not each piece of commodity information has been registered in the shopping list of the shopping memo that is under preparation.

9. The shopping supporting method according to claim 7, further comprising:
a shopping-forgotten list preparing step of comparing commodity information on an electronic receipt that is received after the shopping memo having been prepared with the commodity information registered in the shopping list of said prepared shopping memo to prepare a shopping-forgotten list representing goods forgotten to buy.

10. The shopping supporting method according to claim 9, wherein
at the shopping-forgotten list preparing step, commodity information indicated on an electronic receipt that is received after the shopping-forgotten list having been prepared is compared with said prepared shopping-forgotten list to prepare a new shopping-forgotten list.

11. The shopping supporting method according to claim 7, wherein
at the indication processing step, the electronic receipts are listed and displayed in order of registrations of respective pieces of commodity information of the electronic receipts to the shopping list.

12. The shopping supporting method according to claim 7, wherein
at the indication processing step, the electronic receipts are listed and displayed so as to indicate the number of registrations of commodity information of said electronic receipts to the shopping list in a distinguishable manner.
